(19) United States
(12) Patent Application Publication
(10) Pub. No.: US 2023/0120412 A1
(43) Pub. Date: Apr. 20, 2023

(54) GUNITE TRAILER

(71) Applicant: Brooks STRONG, Houston, TX (US)

(72) Inventor: Brooks STRONG, Houston, TX (US)

(21) Appl. No.: 17/968,452

(22) Filed: Oct. 18, 2022

Related U.S. Application Data
(60) Provisional application No. 63/256,731, filed on Oct. 18, 2021.

(51) Int. Cl. E04G 21/04; B60P 3/16

(52) U.S. Cl. CPC E04G 21/0436; B60P 3/16; E04G 21/0472; E04G 2021/049

(57) ABSTRACT

A gunite trailer includes a frame operable to be coupled to a vehicle. A compressor is disposed on the frame, a cement bin is coupled to the frame and operable to deliver cement, a sand bin is coupled to the frame and operable to deliver sand, and a mixing bin is coupled to the frame and operable to receive the sand from the sand bin and the cement from the cement bin. A delivery connection is operable to receive the sand and the cement from the mixing bin. The delivery connection is operable to be coupled with a delivery system. The delivery system is operable to combine the sand and the cement with a fluid at a point of application to form gunite. The delivery system is operable to convey the gunite to a surface.

### CROSS REFERENCE TO RELATED APPLICATIONS

The present application claims the benefit of U.S. Provisional Application No. 63/256,731, filed Oct. 18, 2021, the contents of which are incorporated herein in their entirety.

### FIELD

The present disclosure relates generally to a gunite system. In at least one example, the present disclosure relates to a gunite trailer that is a self-contained system for mixing, proportioning, and conveying gunite material.

### BACKGROUND

Gunite (also known as dry shotcrete) is dry sand and cement mixed and conveyed pneumatically to a shooting nozzle. Water is added as the mixture is shot directly on the point of application. The resultant concrete has a high cement-to-water ratio and high compaction, making it stronger than most other forms of concrete.

The gunite method keeps the concrete components separated until the moment of application. This eliminates many of the problems that plague wet shotcrete. Gunite can be used for complex jobs like a well-designed swimming pool, important structures for which structural failure is not an option, and structures that are expected to last more than a few months. Because there is no ‘ticking clock’ for the gunite method, gunite affords concrete workmen the time they need to do their jobs properly instead of racing against the setting of wet shotcrete or fighting against the practical logistics of performing a job in the real world.

### BRIEF DESCRIPTION OF THE DRAWINGS

Further features of the present disclosure will become apparent to those skilled in the art to which the present disclosure relates from reading the following specification with reference to the accompanying drawings, in which:

FIG. 1 is an isometric view of a gunite trailer coupled with a vehicle, according to at least one instance of the present disclosure;

FIG. 2 is a perspective view of the gunite trailer;

FIG. 3 illustrates delivery of gunite material to a surface via a gunite delivery gun; and

FIG. 4 is a schematic diagram of a controller.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

Conventionally, a “gunite crew” and/or a “dry gunite crew” (hereinafter “crew”) requires a plurality of heavy-duty trucks, for example multiple class 6, 7, and/or 8 trucks, outfit with volumetric mixers, which deliver dry concrete sand and cement, for example type 1 Portland cement, to a jobsite. These mixers utilize hydraulic driven augers to transfer and blend these materials. The “crew” also requires an air compressor, typically outrigged on another separate heavy-duty truck, equipped with a gunite hose reel and a water hose reel. These plurality of trucks individually supply each of the referenced materials and air to a gunite delivery gun apparatus, yet another separate piece of equipment required for pool building. The present disclosure combines the necessity of multiple, separate heavy-duty trucks and a gunite delivery system into one entity, for example, that can be transported as a trailer with vehicle, for example a medium-duty pick-up truck (which does not require a CDL—Commercial Driver's License).

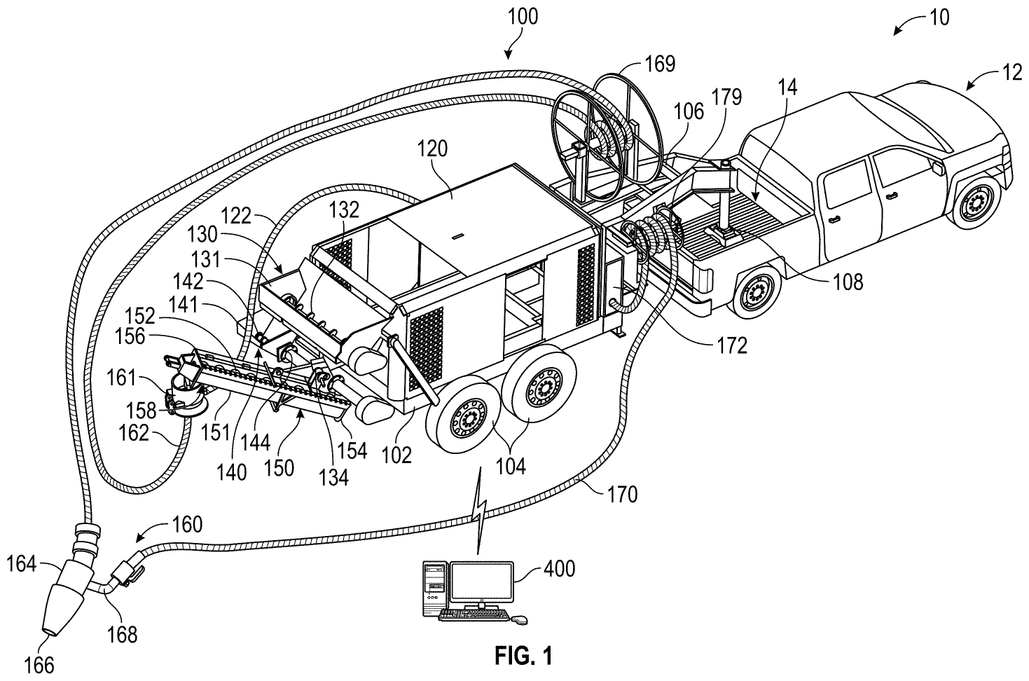

FIG. 1 illustrates a gunite system 10 to be utilized for composing and delivering gunite material (e.g., sand and cement) to a jobsite. As shown in FIG. 1, the gunite system 10 can include a gunite trailer 100. The gunite trailer 100 is a self-contained system for mixing, proportioning, and conveying the gunite material. The gunite trailer 100 can include a frame 102 operable to be coupled to a vehicle 12. The frame 102 can include at least two wheels 104 such that the frame 102 can be pulled along by a vehicle 12. In at least one example, the gunite trailer 100 can include a gooseneck 106 coupled with the frame 102 and operable to couple with the vehicle 12. In some examples, the gooseneck 106 can include a foot 108 that is operable to be received by and coupled with the vehicle 12. For example, as illustrated in FIG. 1, the foot 108 can be received in a bed 14 of the vehicle 12 (e.g., a truck). In at least one example, the vehicle 12 is a truck that can transport the gunite trailer 100. For example, the truck can be a medium-duty pick-up truck. Accordingly, the vehicle 12 does not require a commercial driver's license (CDL), and the gunite trailer 100 can be transported and utilized without the need of special equipment or licenses.

While the figures herein focus on a gunite trailer 100 with a gooseneck 106, in some examples, the gunite trailer 100 may not include a gooseneck 106. In some examples, the gunite trailer 100 can include trailer configurations, for example a step deck trailer, a lowboy trailer, a double drop trailer, a Conestoga trailer, and/or a flatbed trailer. In some examples, the gunite trailer 100 can include a hitch connection. In some examples, the gunite trailer 100 can include trailer connections, for example, receiver hitch, bumper hitch, weight distribution hitch, pintle hitch, and/or 5^{th} wheel hitch. The gunite trailer 100 can be transported with a medium-duty pick-up truck which does not require a CDL. Accordingly, a crew does not have to rent or buy so many trucks and obtain so many licenses. This allows for easier transport and easier management.

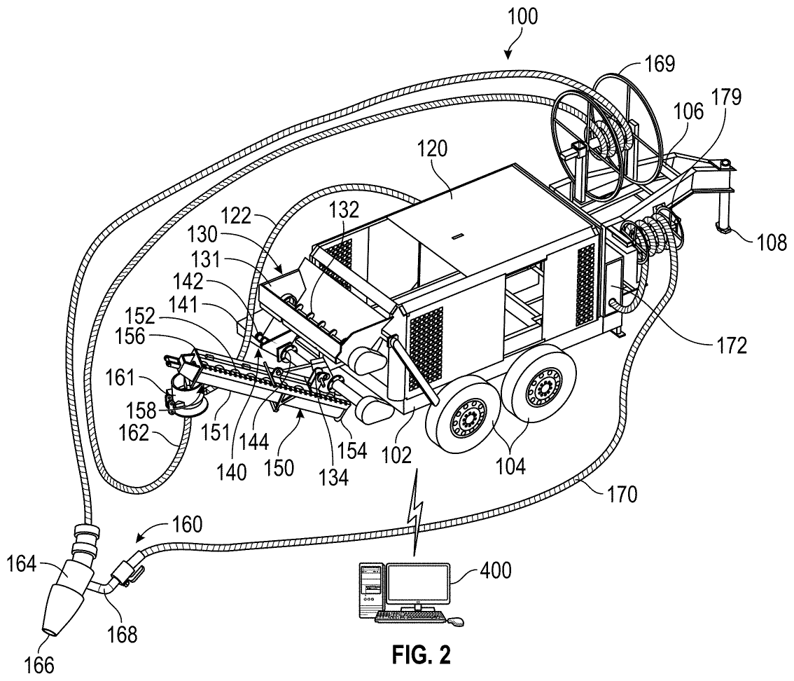

As illustrated in FIGS. 1 and 2, the frame 102 can be operable to receive and/or contain components for mixing, proportioning, and conveying the gunite material. For example, the gunite trailer 100 can include a compressor 120 disposed on the frame 102, a sand bin 130 coupled to the frame 102 and operable to deliver sand, a cement bin 140 coupled to the frame 102 and operable to deliver cement, a mixing bin 150 coupled to the frame and operable to receive the sand from the sand bin 130 and the cement from the cement bin 140, and a delivery connection 161 operable to receive the sand and the cement from the mixing bin 150 and be coupled with a delivery system 160 operable to convey the gunite material to a surface.

The compressor 120 can be operable to provide air to the delivery system 160. The air from the compressor 120 can push the mixed sand and cement through a conduit (e.g., gunite hose 162) for the delivery system 160 and out of the nozzle 164 to the application location. As illustrated in FIGS. 1 and 2, the compressor 120 can be coupled to the delivery system 160 via the delivery connection 161. In at least one example, a compressor conduit 122 can fluidly connect the compressor 120 with the delivery connection 161. The air can be transported from the compressor 120 through the compressor conduit 122 to the delivery connection 161. At the delivery connection 161, the air can push the cement and the sand from the mixing bin 150 through the gunite hose 162 and out of the outlet 166 of the nozzle 164. Accordingly, the compressor 120 is coupled with the delivery connection 161 so that the sand and the cement received in the delivery connection 161 are pneumatically conveyed from the delivery connection 161 through the gunite hose 162 and out of the nozzle 164.

The sand bin 130 can include a sand receptacle 131 operable to receive and store the sand. The sand bin 130 can include a sand auger 142 operable to transfer the sand within the sand receptacle 131 towards the mixing bin 150. The sand auger 142 can be operable to move the sand towards an outlet 144 (e.g., a hole and/or a chute) which leads to the mixing bin 150 to mix with the cement. In at least one example, the sand auger 142 can be disposed horizontally. In some examples, the sand auger 142 can be disposed vertically. In some examples, more than one sand auger 142 can be utilized.

The cement bin 140 can include a cement receptacle 141 operable to receive and store the cement. The cement bin 140 can include a cement auger 142 operable to transfer the cement within the cement receptacle 141 towards the mixing bin 150. The cement auger 142 can be operable to move the cement towards an outlet 144 (e.g., a hole and/or chute) which leads to the mixing bin 150 to mix with the sand. In at least one example, the cement auger 142 can be disposed horizontally. In some examples, the cement auger 142 can be disposed vertically. In some examples, more than one cement auger 142 can be utilized.

In at least one example, as illustrated in FIGS. 1 and 2, the cement bin 140 can be located lower than the sand bin 130. In such a configuration, the cement bin 140 is located lower so that the cement can be loaded in the cement receptacle 141 easier via cement bags. In some examples, a Super Sack attachment can be coupled to the cement bin 140 so that a larger sack of cement can be loaded into the cement bin 140 at a time.

In at least one example, as illustrated in FIGS. 1 and 2, the cement bin 140 can be located on the driver side of the gunite trailer 100. In other words, the cement bin 140 can be located on the gunite trailer 100 proximate a side that corresponds with the driver side of the vehicle 12. Accordingly, the cement bin 140 can be accessible via the driver side of the frame 102. This may be desired as the driver side of the vehicle 12 and subsequently the frame 102 and gunite trailer 100 can be proximate the street. As such, the cement can be loaded into the cement receptacle 141 from the street instead of on the curb or on the property. With such a configuration, the cement can be loaded with ease by hand or with any desired equipment, and the crew would have room to maneuver to access the cement receptacle 141.

In some examples, the cement bin 140 can be located on the passenger side of the frame 102 in circumstances where the passenger side of the vehicle 12 and correspondingly the frame 102 would be proximate the street.

In at least one example, the conveying of the cement from the cement bin 140 and the sand from the sand bin 130 can be individually controlled to delivery the cement and the sand within a predetermined ratio. Accordingly, the gunite material being delivered has the desired ratio and produces the desired results.

In at least one example, the sand bin 130 can include a sand valve 136. The sand valve 136 can be opened and/or closed to control the amount and rate of sand that is moved from the sand receptacle 131 to the mixing bin 150. In at least one example, the sand valve 136 can be communicatively coupled with a controller 400 to control the amount and rate of sand that is moved to the mixing bin 150. In at least one example, the sand auger 131 can be communicatively coupled with the controller 400 to control the amount and rate of sand that is moved within the sand receptacle 142 towards the mixing bin 150. Accordingly, the proportion of sand to cement can be managed.

In at least one example, the cement bin 140 can include a cement valve 146. The cement valve 146 can be opened and/or closed to control the amount and rate of cement that is moved from the cement receptacle 141 to the mixing bin 150. In at least one example, the cement valve 146 can be communicatively coupled with a controller 400 to control the amount and rate of cement that is moved to the mixing bin 150. In at least one example, the cement auger 141 can be communicatively coupled with the controller 400 to control the amount and rate of cement that is moved within the cement receptacle 142 towards the mixing bin 150. Accordingly, the proportion of sand to cement can be managed.

The cement and the sand are moved from the cement bin 140 and the sand bin 130 to the mixing bin 150. The mixing bin 150 can include a mixing receptacle 151 operable to receive and store the cement and the sand. The mixing bin 150 can include a mixing auger 152 operable to mix and transfer the cement and the sand through the mixing bin 150 to the delivery connection 161. The mixing receptable 151 can include a receiving portion 154 where the outlets 134, 144 deposit the cement and sand into the mixing receptacle 151. The mixing auger 152 can then mix and transfer the cement and the sand from the receiving portion 154 towards the outlet portion 156. At the outlet portion 156, the mixed cement and sand can move from the mixing receptacle 151 out of an outlet 158 to the delivery connection 161.

In at least one example, the mixing bin 150 can be raised and lowered to move material from the sand bin 130 and the cement bin 140 to the delivery system 160. When the mixing bin 150 is raised, the outlet portion 156 of the mixing bin 150 is raised away from the ground, and the cement and sand in the mixing receptacle 151 is prevented from exiting the outlet 158. When the mixing bin 150 is lowered, the outlet portion 156 of the mixing bin 150 is lowered towards the ground, and the cement and sand in the mixing receptacle 151 can flow towards the outlet 158. In some examples, when the mixing bin 150 is lowered, the outlet portion 156 is lowered for easy connection to the delivery system 160.

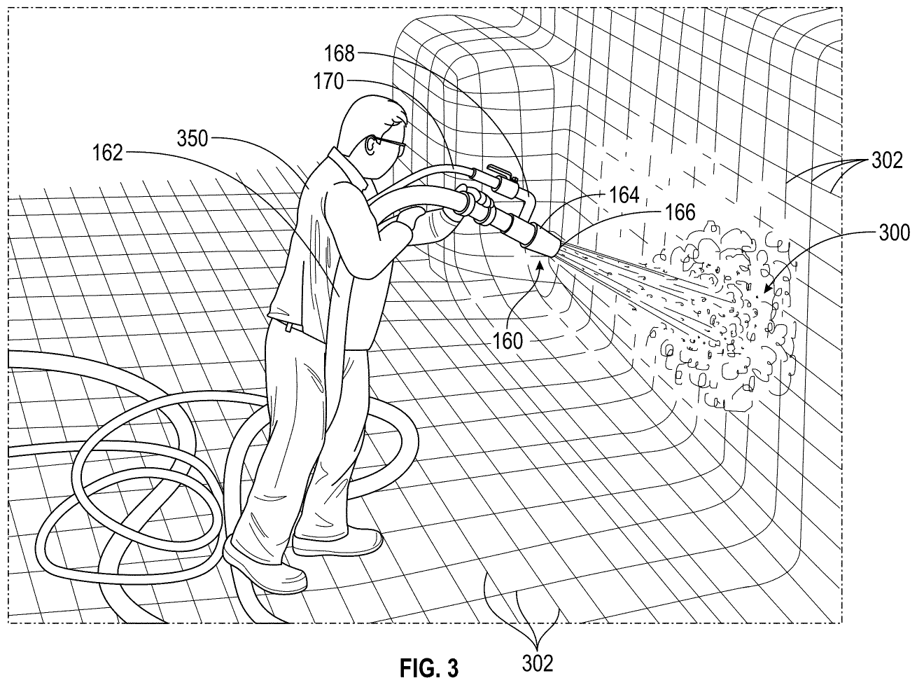

The delivery connection 161 is operable to receive the mixed cement and sand from the mixing bin 150 and transition the mixed cement and sand to the delivery system 160. In at least one example, the delivery connection 161 can be in fluid connection with the mixing bin 150. In some examples, the delivery connection 161 can be directly coupled with the mixing bin 150. In at least one example, the delivery system 160 is in fluid connection with the mixing bin 150. In some examples, the delivery system 160 can be directly coupled with the delivery connection 161. In some examples, the delivery system 160 can be directly coupled with the mixing bin 150. In some examples, the delivery system 160 can be detachably coupled with the mixing bin 150. In some examples, the delivery system 160 can be detachably coupled with the delivery connection 161. Referring also to FIG. 3, the delivery system 160 is operable to convey the gunite to the surface 300 for application. In at least one example, as illustrated in FIG. 3, the surface 300 can have a frame 302 (e.g., wire frame) formed thereon to assist in maintaining the structural integrity of the gunite. Referring to FIGS. 1-3, the delivery system 160 can include a gunite hose 162 and a nozzle 164. The gunite hose 162 can be operable to be coupled with the delivery connection 161 and the nozzle 164. The gunite hose 162 receives the mixed cement and sand from the delivery connection 161 and transports the mixed cement and sand to the nozzle 164. The mixed cement and sand can be conveyed through the gunite hose 162 by pneumatic air delivered from the compressor 120 via the compressor conduit 122 to the delivery connection 161.

In at least one example, the gunite trailer 100 can include a gunite hose reel 169 operable to store and convey the gunite hose 162. The gunite hose 162 can be wound around the gunite hose reel 169 and conveyed as needed to the application surface. In at least one example, the gunite hose 162 can be detachably coupled with the delivery connection 161. When detached, the gunite hose 162 can be wound around the gunite hose reel 169 for storage. In some examples, the gunite hose 162 can be attached to the delivery connection 161 at the jobsite.

In at least one example, the delivery system 160 can include a fluid hose 170 operable to be coupled with the nozzle 164. For example, as illustrated in FIGS. 1 and 2, the fluid hose 170 can be fluidly coupled with the nozzle 164 via a fluid port 168. The fluid hose 170 can be fluidly coupled with a fluid source 172 so that the fluid hose 170 is operable to deliver the fluid from the fluid source 172 to the point of application. At the point of application, the fluid mixes with the mixed cement and sand to form gunite, and the gunite is conveyed out of the nozzle 164 via the outlet 166 of the nozzle 164. The point of application to form gunite is at the nozzle 164. The fluid is not supplied to the sand and cement mixture until the mixture reaches the nozzle 164. Fluid (e.g., water) is added as the mixture is shot directly on the point of application. The resultant concrete has a high cement-to-water ratio and high compaction, making it stronger than most other forms of concrete. Additionally, as the gunite is formed at the point of application instead of pre-mixed, the crew is not working against a clock of a pre-mixed composition setting.

In at least one example, the gunite trailer 100 can include a fluid hose reel 179 operable to store and convey the fluid hose 170. The fluid hose 170 can be wound around the fluid hose reel 179 and conveyed as needed to the application surface. In at least one example, the fluid hose 170 can be detachably coupled with the nozzle 164. When detached, the fluid hose 170 can be wound around the fluid hose reel 179 for storage. In some examples, the fluid hose 170 can be attached to the nozzle 164 at the jobsite.

In at least one example, the fluid includes water. In at least one example, as illustrated in FIGS. 1 and 2, the fluid source 172 can be disposed on the frame 102. In some examples, the fluid source 172 can be a water sump such as a tank of water separate from the gunite trailer 100. In some examples, the fluid source 172 can be a garden hose spigot from the property.

Conventionally, the delivery system is a separate piece of equipment, where mixing trucks deposit sand and cement into a feed wheel. Accordingly, conventional mixing trucks can move and be replaced while the feed wheel and delivery system stay in one place. The presently disclosed delivery system 160 is coupled to the mixing bin 150 which is coupled to the frame 102 of the gunite trailer 100. Accordingly, there is not a need of a separate piece of equipment. The delivery system 160 is operable to eject the sand and cement mixture out of a nozzle 164 along with the fluid. The sand and cement mixture moves from the mixing bin 150 into the gunite hose 162 from the gunite hose reel 169. Air from the compressor 120 pushes the sand and cement mixture through the gunite hose 162 and out of the nozzle 164.

The gunite trailer 100 provides a single piece of equipment that combines the conventional need of multiple trucks and pieces of equipment. The gunite trailer 100 is configured to permit ease of use and increased safety for loading, mixing, and conveying gunite to the application surface. Additionally, the gunite trailer can be towed with a commercial driver's license. Accordingly, gunite and/or pool companies with less capital or with smaller projects can complete projects without the need to invest in licenses, multiple trucks, and/or multiple pieces of equipment.

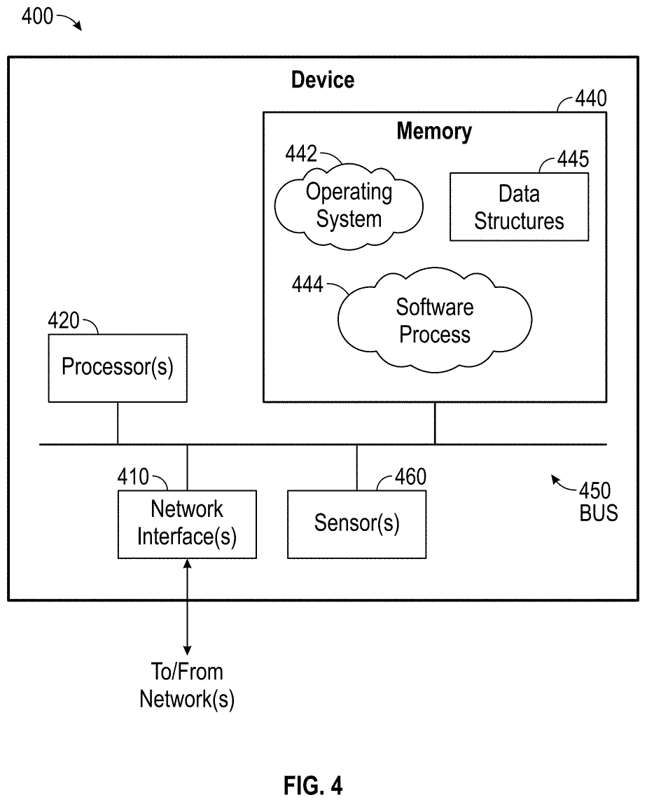

FIG. 4 is a block diagram of an exemplary controller 400. The controller 400 can be utilized from the surface and/or remotely, as illustrated in FIGS. 1-3. Controller 400 is configured to perform processing of data and communicate with the valves (e.g., sand valve 136 and/or cement valve 146), for example as illustrated in FIGS. 1-3. In operation, controller 400 communicates with one or more of the above-discussed components and may also be configured to communication with remote devices/systems.

As shown, controller 400 includes hardware and software components such as network interfaces 410, at least one processor 420, sensors 460 and a memory 440 interconnected by a system bus 450. Network interface(s) 410 can include mechanical, electrical, and signaling circuitry for communicating data over communication links, which may include wired or wireless communication links. Network interfaces 410 are configured to transmit and/or receive data using any variety of different communication protocols.

Processor 420 represents a digital signal processor (e.g., a microprocessor, a microcontroller, or a fixed-logic processor, etc.) configured to execute instructions or logic to perform tasks in a wellbore environment. Processor 420 may include a general purpose processor, special-purpose processor (where software instructions are incorporated into the processor), a state machine, application specific integrated circuit (ASIC), a programmable gate array (PGA) including a field PGA, an individual component, a distributed group of processors, and the like. Processor 420 typically operates in conjunction with shared or dedicated hardware, including but not limited to, hardware capable of executing software and hardware. For example, processor 420 may include elements or logic adapted to execute software programs and manipulate data structures 445, which may reside in memory 440.

Sensors 460 typically operate in conjunction with processor 420 to perform measurements, and can include special-purpose processors, detectors, transmitters, receivers, and the like. In this fashion, sensors 460 may include hardware/software for generating, transmitting, receiving, detection, and/or logging parameters.

Memory 440 comprises a plurality of storage locations that are addressable by processor 420 for storing software programs and data structures 445 associated with the embodiments described herein. An operating system 442, portions of which may be typically resident in memory 440 and executed by processor 420, functionally organizes the device by, inter alia, invoking operations in support of software processes and/or services 444 executing on controller 400. These software processes and/or services 444 may perform processing of data and communication with controller 400, as described herein. Note that while process/service 444 is shown in centralized memory 440, some examples provide for these processes/services to be operated in a distributed computing network.

Other processor and memory types, including various computer-readable media, may be used to store and execute program instructions pertaining to the wellbore tractor described herein. Also, while the description illustrates various processes, it is expressly contemplated that various processes may be embodied as modules having portions of the process/service 444 encoded thereon. In this fashion, the program modules may be encoded in one or more tangible computer readable storage media for execution, such as with fixed logic or programmable logic (e.g., software/computer instructions executed by a processor, and any processor may be a programmable processor, programmable digital logic such as field programmable gate arrays or an ASIC that comprises fixed digital logic. In general, any process logic may be embodied in processor 420 or computer readable medium encoded with instructions for execution by processor 420 that, when executed by the processor, are operable to cause the processor to perform the functions described herein.

Additionally, the controller 400 can apply machine learning, such as a neural network or sequential logistic regression and the like, to determine relationships between the parameters of the gunite material. For example, a deep neural network may be trained in advance to capture the complex relationship between the ratio of cement and sand and the operation of the cement bin and the sand bin. In some examples, the deep neural network may be trained to capture the complex relationship between the ratio of cement, sand, and fluid to obtain the desired gunite material. This neural net can then be deployed in the determination of how to control the valves combine the gunite material.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. Rather, the described features and steps are disclosed as possible components of systems and methods within the scope of the appended claims.

What is claimed is:

1. A gunite trailer comprising:
a frame operable to be coupled to a vehicle;
a compressor disposed on the frame;
a cement bin coupled to the frame and operable to deliver cement;
a sand bin coupled to the frame and operable to deliver sand;
a mixing bin coupled to the frame and operable to receive the sand from the sand bin and the cement from the cement bin; and
a delivery connection operable to receive the sand and the cement from the mixing bin, the delivery connection operable to be coupled with a delivery system, wherein the delivery system is operable to combine the sand and the cement with a fluid at a point of application to form gunite, wherein the delivery system is operable to convey the gunite to a surface.

2. The gunite trailer of claim 1, wherein the delivery system includes a gunite hose and a nozzle, wherein the gunite hose is operable to be coupled with the delivery connection and the nozzle.

3. The gunite trailer of claim 2, wherein the delivery system includes a fluid hose operable to be coupled with the nozzle, wherein the fluid hose is operable to deliver the fluid from a fluid source to the point of application.

4. The gunite trailer of claim 3, wherein the fluid is water.

5. The gunite trailer of claim 3, wherein the fluid source is disposed on the frame.

6. The gunite trailer of claim 3, further comprising a gunite hose reel operable to store and convey a gunite hose.

7. The gunite trailer of claim 3, further comprising a fluid hose reel operable to store and convey the fluid hose.

8. The gunite trailer of claim 2, wherein the point of application is at the nozzle.

9. The gunite trailer of claim 2, wherein the compressor is coupled with the delivery connection so that the sand and the cement received in the delivery connection are pneumatically conveyed from the delivery connection through the gunite hose and out of the nozzle.

10. The gunite trailer of claim 1, wherein the cement bin is accessible via a driver side of the frame.

11. The gunite trailer of claim 1, wherein the cement bin is located lower than the sand bin.

12. The gunite trailer of claim 1, wherein the conveying of the cement from the cement bin and the sand from the sand bin are individually controlled to deliver the cement and the sand within a predetermined ratio.

13. The gunite trailer of claim 1, wherein the frame includes a gooseneck operable to be coupled with the vehicle.

14. The gunite trailer of claim 1, wherein the mixing bin includes a mixing auger to mix and transfer the cement and the sand through the mixing bin to the delivery connection.

15. The gunite trailer of claim 1, wherein the cement bin includes a cement auger operable to transfer the cement towards the mixing bin.

16. The gunite trailer of claim 1, wherein the sand bin includes a sand auger operable to transfer the sand towards the mixing bin.
